(19) United States
(12) Patent Application Publication
(10) Pub. No.: US 2016/0368304 A1
(43) Pub. Date: Dec. 22, 2016

(54) Multi-Sensory Presentation Device

(71) Applicant: Video Plus Print Company, Hong Kong (CN)

(72) Inventors: Vijay Mahbubani, Hong Kong (CN); Xugui Yu, Hong Kong (CN)

(21) Appl. No.: 15/184,687

(22) Filed: Jun. 16, 2016

Related U.S. Application Data
(60) Provisional application No. 62/180,186, filed on Jun. 16, 2015.

(51) Int. Cl. B42D 1/00; B05B 9/01; G09B 5/02; B42D 15/02; B42D 3/12; G09F 1/04; B42D 15/04

(52) U.S. Cl. CPC B42D 1/007; G09F 1/04; B05B 9/01; B42D 15/042; B42D 15/022; B42D 15/027; B42D 3/123; G09B 5/02

(57) ABSTRACT

A multi-sensory presentation device is disclosed. The device may presenting information, such as for telling a story, promoting a product, or the like, by smell (olfactorily) and/or by touch (tactilely).

### BACKGROUND

Presentation devices are known which may present information, such as stories or advertising, in the form of a printed book. The book may further include a speaker for presenting information audibly and/or a visual display, such as a conventional LED or LCD display, for presenting information visually. The audibly presented information and the visually presented information may be stored in memory associated with the device, or it may be streamed and played in real-time. See for example: U.S. Pat. No. 7,224, 934 to Mullen; U.S. Pat. No. 8,011,122 to Clegg et al.; and U.S. Pat. No. 8,341,858 to Clegg et al., the disclosures of which are expressly incorporated herein by reference.

Other devices are known which may present a scent in conjunction with a fixed image. See for example Clegg, U.S. Pat. No. 7,918,043.

However such devices fail to provide a complete visual and sensory experience.

### SUMMARY

In accordance with the present invention, a multi-sensory presentation device may present information, such as for telling a story, promoting a product, or the like, which may also present the information to a user by smell (olfactorily) or by touch (tactilely).

### BRIEF DESCRIPTION OF THE DRAWINGS

FIG. 1 is a perspective view of one embodiment of a multi-sensory presentation device in accordance with the present invention;

FIG 1a is a sectional view of the presentation device of FIG. 1, taken along line 1a-1a thereof;

FIG. 2 is a more detailed view of certain components of the presentation device of FIG. 1; and

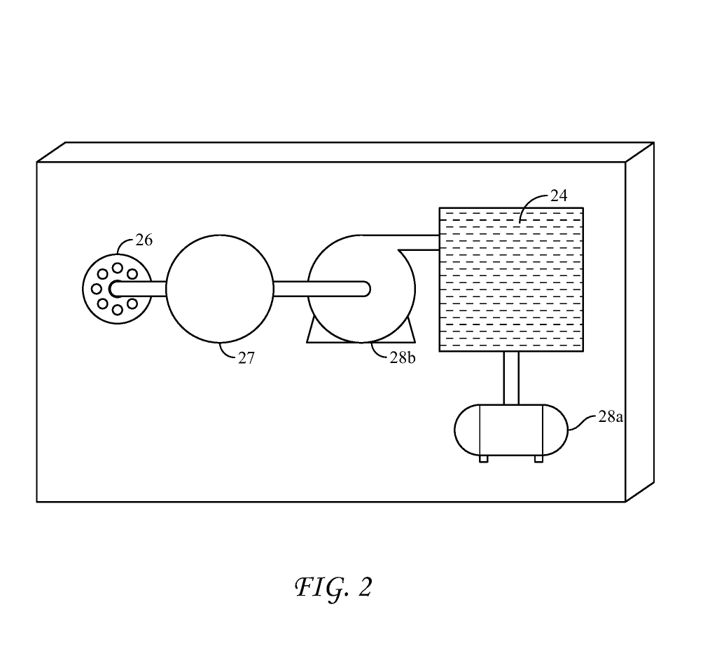

FIG. 3 is a block diagram of other embodiments of the multi-sensory presentation device in accordance with the present invention.

### DETAILED DESCRIPTION OF THE INVENTION

While the present invention is susceptible to embodiment in many different forms, there will be described herein in detail, specific embodiments thereof with the understanding that the present disclosure is to be considered as an exemplification of the principles of the invention and is not intended to limit the invention to the specific embodiments illustrated.

In accordance with the invention, a multi-sensory presentation device may be in the form of a foldable structure, having a front and a back cover, similar to a standard greeting card, mailer magazine, book, brochure, packaging. Alternatively the device may be in the form of a postcard, having no foldable structure. The device may be concealed between two opposing leafs, forming a page. The device may include a power source, rechargeable or otherwise, a printed circuit board, tubing, some type of a liquid bearing reservoir, or container, such as a capsule, bottle or pouch, that may store some amount of aromatic liquid.

The liquid may be transported into a conventional ultrasonic device. The ultrasonic device may use sound and/or vibration frequencies, or heat, to diffuse or disperse the aromatic liquid such as in the form of liquid droplets, vapor, or the like, into the ambient environment of the device. The tubes in the device permit the liquid to flow from one compartment into another compartment to be processed before being diffused out in liquid or vapor form.

The liquid may be transported either by manual or a mechanical force, such as a resistive button/capacitive button, some sort of a sensor or such other means, that triggers the liquid to be transported from the liquid container, into the ultrasonic device, which liquid is then released out of the device through one or more holes. The means by which the liquid moves from one point to another point may be either by physical compression, by a motor, or such other mechanism as would be appropriate.

The device may have multiple liquid bearing containers, or reservoirs, containing respective multiple types of scented liquids. The device may include multiple buttons/multiple trigger mechanisms, or multiple locations where a user can push into or touch a particular section on the device, causing the liquid bearing container that may have one or more dispensing holes to allow the diffused liquid or vapor to be released, allowing the user to selectively smell each diffused liquid/vapor, at least one at a time.

The device may include a video display screen, a light display, LED, fibre optics, audio components, solar panels for power, a component that requires any kind of a motor and/or a printed circuit board that communicates with the user to take some sort of an action or engages the user to pay attention to this device.

The device may include a mechanism permitting the reservoir to be detached and replaced, such as when the liquid bearing container becomes empty.

The device may include some sort of waterproof, or water resistive, foldable structure to prevent damage to the device due to the liquid or vapor being dispersed from the device.

The device may be a foldable structure having a front and back cover, such as a standard greeting card, mailer magazine, book, brochure, packaging), or the device may be in the form of a postcard, having no foldable structure. The device may be concealed in a void formed between two leafs, the two leafs cooperatively forming a page. The device may have a power source, non-rechargeable or rechargeable, printed circuit board, tubes, and some type of emulsion bearing container, which stores some amount of an oil/water emulsion such as a cream or gel.

The emulsion may be pushed out of the emulsion-bearing compartment, through the tubes and out of the device. The emulsion may be pushed either by manual or a mechanical force, such as a resistive button/capacitive button, some sort of a sensor or any other means, which may trigger the emulsion to move, either by positive or negative pressure (ie., either push or suck) out of the container and out of the device through one or more dispensing holes. The means by which the emulsion moves from one point to another point may be either by compression (sucked or push function) using manual force or by a motor.

The device may have multiple emulsion bearing containers containing multiple types of emulsions with multiple buttons/multiple trigger mechanisms or multiple locations where a user can push into or touch a particular section on the device, causing the container having one or more holes to allow the emulsion to be released, allowing the user to smell or touch each of the respective emulsions at least one at a time.

The device may include a video screen, light display, LED, fibre optics, audio component, solar panel, a component that requires any kind of a motor and/or a printed circuit board that communicates with the user to take some sort of an action or engages the user to pay attention to this device.

The emulsion-bearing container may be detachable and replaceable once the container is empty.

The device may include some form of a waterproof or water resistive foldable structure to prevent the printed card, brochure, magazine, or postcard to not be damaged due to the emulsion being dispersed from the device.

The device may be configured to only disperse the substance, liquid or emulsion, when the device is powered on, such as by opening the cover of a brochure, book, card.

Unlike soap dispensers or antibacterial dispensers that dispense the cream like substance when a user uses force to push a lever or it senses some type of motion around a particular area, the present device may be a foldable structure, it is in a printed paper which is portable and can be distributed via mail, not stuck on the wall, for example.

The present device may be fitted with a multisensory experience that communicates with the user to take certain action. The device may be powered on and off on demand by moving the foldable structure from closed (off position) and opening it (bring it to ON/READY position)

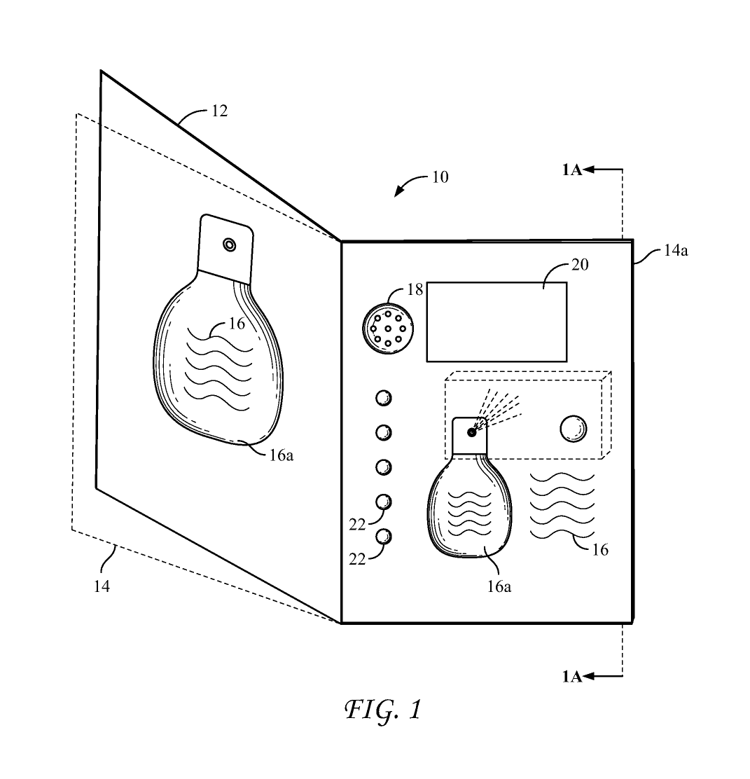

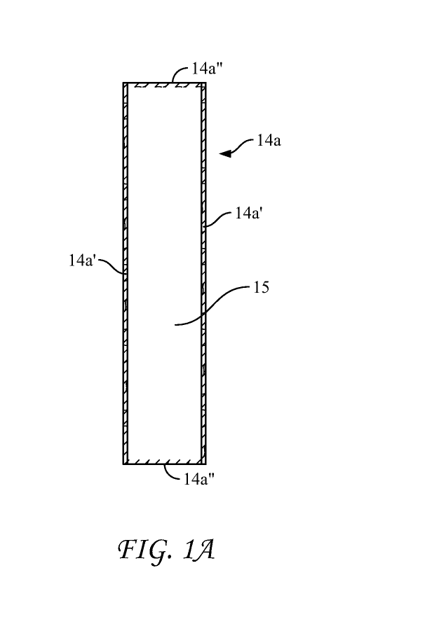

One particular embodiment of a presentation device 10 in accordance with the present invention is illustrated in FIGS. 1 and 1A. The presentation device 10 may include a cover page 12, and one or more subsequent inner pages 14. One of the inner pages 14 may be a rear page 14a. The rear page 14a may be formed of two opposing sheets, or leafs, 14a′, sealed together about their periphery, such as by a bead of sealant 14a″, and defining a void 15 there between. As discussed below, the void 15 may be utilized to contain various elements of the presentation device 10.

As is known in the art, the cover page 12 and the inner pages 14, 14a may include text and/or artwork 16. The artwork may be a picture of a product to be advertised, such as a bottle of perfume 16a. As is also known in the art, the inner page 14 further may include a speaker 18, a visual display device 20, as well as electronics 21, described below, including such conventional components as a microprocessor, memory, a power supply and interconnecting circuitry, for presenting information stored in the memory, audibly via the speaker 18 and/or visually via the visual display device 20. The electronics 21 may also include conventional wireless communication circuitry to receive and present conventional streaming data for presenting streamed information audibly via the speaker 18 and/or visually via the visual display device 20.

The device 10 may include a plurality of conventional switches to perform various desired functions. The switches may be mechanical, capacitive, magnetic, light receptive, or the like, as desired.

For example the device may include a switch (not shown) to detect when the cover page 12 has been opened to expose one of the inner pages 14, and then present information audibly via the speaker 18 and/or visually via the visual display device 20, when the cover page 12 is opened to a particular one of the inner pages 14.

Additional switches 22, such as conventional push-button switches, conventional capacitive touch switches or conventional light sensors may be provided to selectively present audible and/or visual information.

In addition to the foregoing, the device 10 may also include a reservoir or container 24, such as a storage pouch, disposed within the void 15 within the rear page 14a, which may contain a scented liquid, such as a perfume, a cream, a gel, or the like, which may be dispensed via a port 26. The scented liquid may be dispensed via a dispenser 27, upon actuation of an actuator 28.

The dispenser 27 may be an ultrasonic fogger, a heating element, an atomizer, a roller ball, or the like.

The actuator 28 may include a mechanically operated compressor 28a, which may pump air into the container 24, forcing the fragrance out of the container via the port 26. Alternatively the container 24 may be pre-pressurized, and the actuator 28 may cause the release of the pressurized fragrance via the port 26. Still further, the container 24 may include a miniature electric pump 28b, and the actuator 28 may actuate the electric pump 28b, to force the fragrance out of the container 24 via the port 26.

Dispensing of the scented liquid may also be timed to occur, such as under the control of the microprocessor, a time period after some occurrence, such as after the opening of the cover page 12.

In a further embodiment of the device 10, the container 24 may include a liquid, or other flowable substance, such as a scented cream or paste-like product. The container 22 may further include a roller-ball dispenser, such that the rolling of a finger over the roller-ball may dispense amounts of the scented liquid, or other flowable substance.

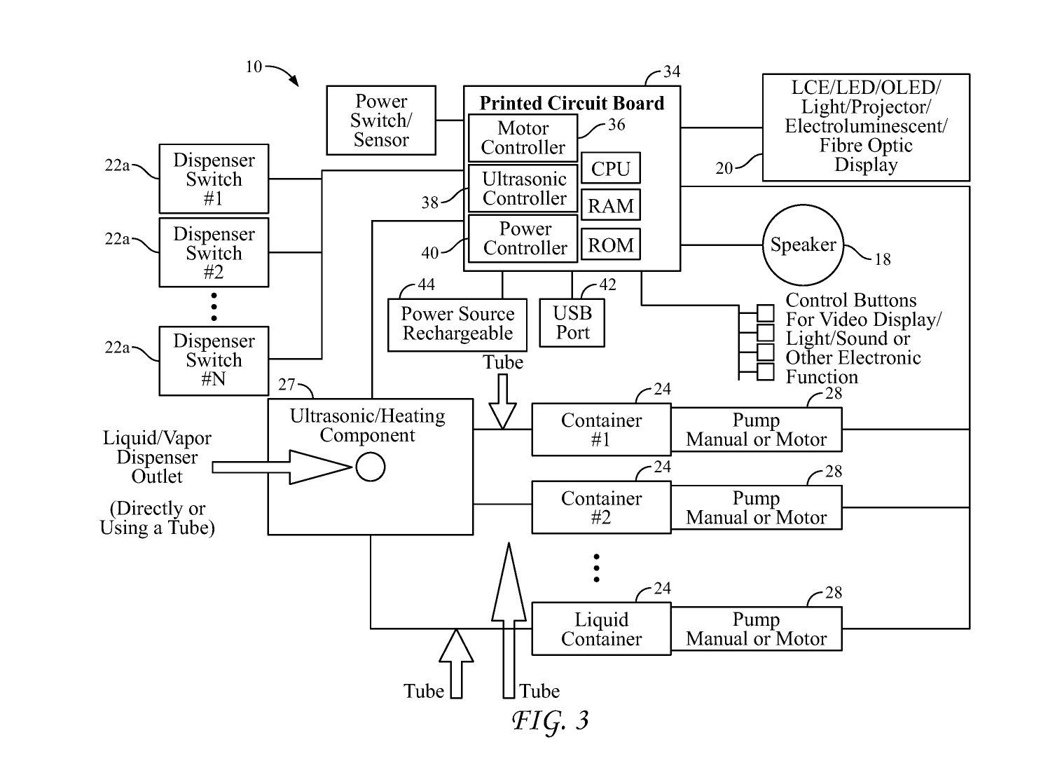

FIG. 3 illustrates other aspects of embodiments of the present invention. For example, the presentation device 10 may include multiple containers 24, each of which may contain a different liquid. Each of the respective containers may include a respective actuator for dispensing the respective liquid, upon command from a respective one of the dispenser switches 22a.

The electronics 21 may be mounted on a printed circuit board 34 and include such components as a motor controller 36, a dispenser controller 38, such as an ultrasonic controller, and a power controller 40. The presentation device may include a conventional USB port 42 for uploading video files. The presentation device may still further include a power source 44, such as a battery, rechargeable or otherwise, or a solar array. The USB port may permit charging of, or data transfer between, an external personal communication device, such as a smartphone.

In addition to, or as an alternative to, the video display 20 discussed above, the presentation device 10 may include, or permit use of, other types of displays 10, such as a conventional projector, fibre optic displays, and the like.

From the foregoing it will be observed that numerous variations and modifications may be effected without departing from the spirit and scope of the invention. It is to be understood that no limitation illustrated herein is intended, or inferred. It is, of course, intended to cover by the appended claims all such modifications as fall within the scope of the claims.

What is claimed:

1. A multi-sensory presentation device for presenting a scent enhanced video message to a user, the presentation device comprising:
a page having a first leaf and an opposing second leaf, the first leaf being joined to the second leaf forming a void there between;
a video display;
circuitry including a microprocessor and memory, the memory adapted for storing a video file of the video message to be viewed on the video display under control of the microprocessor;
a reservoir disposed within the void, the reservoir adapted for containing a scented liquid;
a dispenser for dispensing a portion of the scented liquid externally from the presentation device into an ambient environment of the user; and
a transfer mechanism for transferring the liquid from the reservoir to the dispenser.

2. The presentation device of claim 1, wherein the dispenser comprises a diffuser for diffusing a dispersion of the liquid externally from the presentation device into the ambient environment of the user.

3. The presentation device of claim 1, wherein the scented liquid is a perfume.

4. The presentation device of claim 1, wherein the scented liquid is a cream.

5. The presentation device of claim 1, wherein the scented liquid is a gel.

6. The presentation device of claim 1 wherein the transfer mechanism comprises an electric pump.

7. The presentation device of claim 1 wherein the transfer mechanism comprises a mechanical pump.

8. The presentation device of claim 1 wherein the video display is disposed substantially within the void.

9. The presentation device of claim 1 including a plurality of reservoirs disposed within the void, the reservoirs each adapted for containing a scented liquid; and
wherein the transfer mechanism includes means for selectively transferring a quantity of each of the liquids from the reservoir to the dispenser for dispensing externally from the presentation device.

10. The presentation device of claim 1 including a power source.

11. The presentation device of claim 10, wherein the power source comprises a photocell.

12. The presentation device of claim 11 including means adapted for coupling a remote personal communication device to the presentation device to permit charging of the personal communication device.

13. The presentation device of claim 2 wherein the diffuser comprises an ultrasonic fogger.

14. The presentation device of claim 2 wherein the diffuser comprises a heating element.

15. The presentation device of claim 1 wherein the diffuser comprises an atomizer.

16. The presentation device of claim 1 configured as a single page.

17. The presentation device of claim 1 configured as a plurality of pages.

18. The presentation device of claim 1 wherein the reservoir is removably replaceable.

19. The presentation device of claim 1 including means for actuating the dispenser following a period of time after opening the presentation device.
